(19) United States
(12) Patent Application Publication
(10) Pub. No.: US 2025/0340127 A1
(43) Pub. Date: Nov. 6, 2025

(54) MOTOR FLUXING ACTIVATION

(71) Applicant: Caterpillar Inc., Peoria, IL (US)

(72) Inventor: Rodney Lee MENOLD, Hanna City, IL (US)

(73) Assignee: Caterpillar Inc., Peoria, IL (US)

(21) Appl. No.: 18/656,444

(22) Filed: May 6, 2024

(51) Int. Cl. B60L 15/20

(52) U.S. Cl. CPC B60L 15/20; B60L 2240/486; B60L 2250/26

(57) ABSTRACT

In some implementations, a supervisory controller may receive a vehicle status signal output by a vehicle sensor. The supervisory controller may determine a readiness state for vehicle movement in accordance with the vehicle status signal. The supervisory controller may output a control signal commanding a motor controller to perform a fluxing operation on an electric motor in accordance with the readiness state.

### TECHNICAL FIELD

The present disclosure relates generally to a machine with an electric motor and, for example, to performing a fluxing operation on the electric motor in accordance with a readiness state of the machine.

### BACKGROUND

Heavy work machines, such as machines used for construction, mining, and agriculture, may apply alternative power sources to be more sustainable and environmentally friendly. One alternative power source may include using an electric motor to propel the machine. Electric motors use electromagnetic induction, which involves the conversion of electrical energy into mechanical energy through the interaction of magnetic fields. A magnetic field is generated either by permanent magnets or electromagnets within the motor, and the magnetic field of the motor interacts with the magnetic field induced in windings of the motor, creating a force that rotates an armature. By controlling the flow of electric current through the windings, it is possible to manage the speed and power output of the electric motor.

The electric motor may be energized through a fluxing operation. The fluxing operation may be performed periodically to keep the electric motor energized so that the electric motor can instantly propel the work machine as needed. Continually performing fluxing operations, however, can be costly in terms of energy usage and wear on electric motor and other components of the work machine.

U.S. Pat. No. 9,604,625 (the '625 patent) discloses a process for controlling a vehicle start-stop operation having a hybrid drive with an internal-combustion engine and an electric motor, a service brake with an ABS and an electric parking brake. In the case of a starting prompt, for example, at a traffic light in front of which the vehicle is stopped, the locked parking brake is automatically released and the vehicle is started by the electric motor. For this purpose, the accelerator pedal and the service brake pedal are monitored and their conditions are evaluated. For example, when the service brake pedal is released and the accelerator pedal is operated, the starting operation will take place.

The control system of the present disclosure solves one or more problems in the art.

### SUMMARY

A machine may include one or more sensors, each being configured to monitor a vehicle status and output a vehicle status signal; an electric motor; a motor controller configured to perform a fluxing operation on the electric motor; and a supervisory controller configured to receive the one or more vehicle status signals output by the one or more sensors, determine a readiness state for vehicle movement, and output a control signal to the motor controller to command the motor controller to perform the fluxing operation on the electric motor in accordance with the readiness state.

A supervisory controller may include one or more memories; and one or more processors, communicatively coupled to the one or more memories, configured to: receive one or more vehicle status signals output by one or more vehicle sensors; determine a readiness state for vehicle movement in accordance with the one or more vehicle status signals; and output a control signal commanding a motor controller to perform a fluxing operation on an electric motor in accordance with the readiness state.

A method may include receiving a vehicle status signal output by a vehicle sensor; determining a readiness state for vehicle movement in accordance with the vehicle status signal; and outputting a control signal commanding a motor controller to perform a fluxing operation on an electric motor in accordance with the readiness state.

### BRIEF DESCRIPTION OF THE DRAWINGS

FIG. 1 is a diagram of an example heavy work machine with a motor fluxing activation feature.

FIG. 2 is a diagram of an example supervisory controller associated with performing a fluxing operation.

FIG. 3 is a flowchart of an example process associated with performing a fluxing operation on an electric motor of a work machine.

### DETAILED DESCRIPTION

This disclosure relates to performing a fluxing operation, which is applicable to any work machine that uses an electric motor. For example, the work machine may be a vehicle, a compactor machine, a paving machine, a cold planer, a grading machine, a backhoe loader, a wheel loader, a harvester, an excavator, a motor grader, a skid steer loader, a tractor, a dozer, or the like. The work machine may have various applications such as construction, agriculture, or locomotive, among other examples.

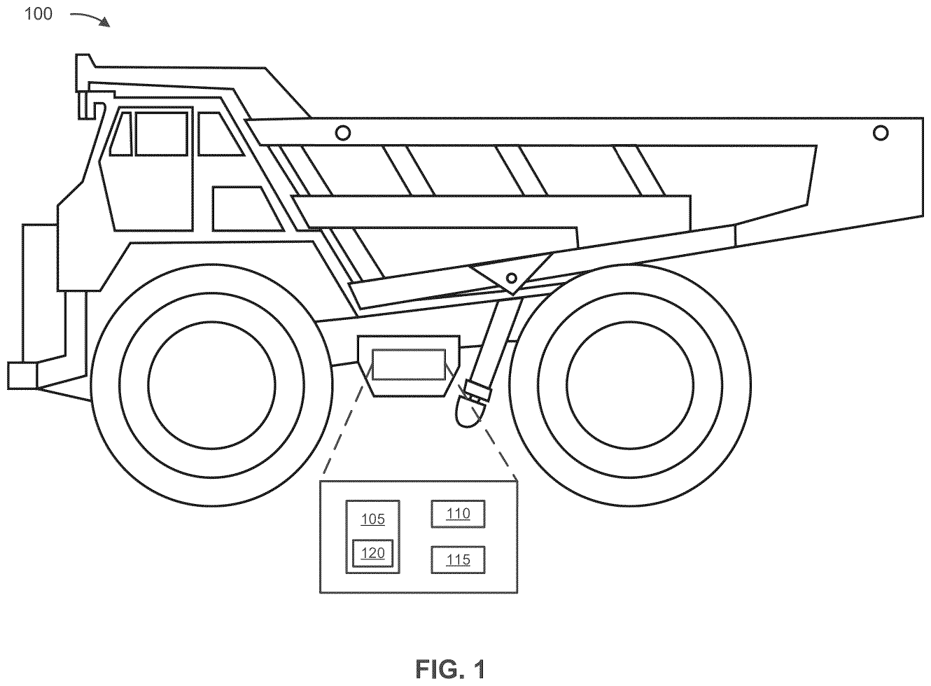

FIG. 1 is a diagram of an example heavy work machine 100 with a motor fluxing activation feature. As shown in FIG. 1, the heavy work machine 100 may be a vehicle that includes an electric motor 105, vehicle sensors 110, and a control system 115.

The electric motor 105 may include a rotor and a stator. The rotor is the rotating part of the motor, which turns within the stator. The stator remains stationary during operation of the electric motor 105. The electric motor 105 may be powered by a power source such as a battery or fuel cell. The electric motor 105 may operate in accordance with a magnetic flux in accordance with the energy output by the power source. For example, during a fluxing operation, electric current output by the power source may flow through windings of the stator and generate a magnetic field. The magnetic field may interact with windings of the rotor, causing the rotor to rotate a shaft that is operably connected to a drive system. Accordingly, energizing the electric motor 105 may cause the shaft to rotate, and the torque provided by the shaft to the drive system may propel the work machine 100. The operation of the electric motor 105 may be controlled by a motor controller 120, as discussed in greater detail below.

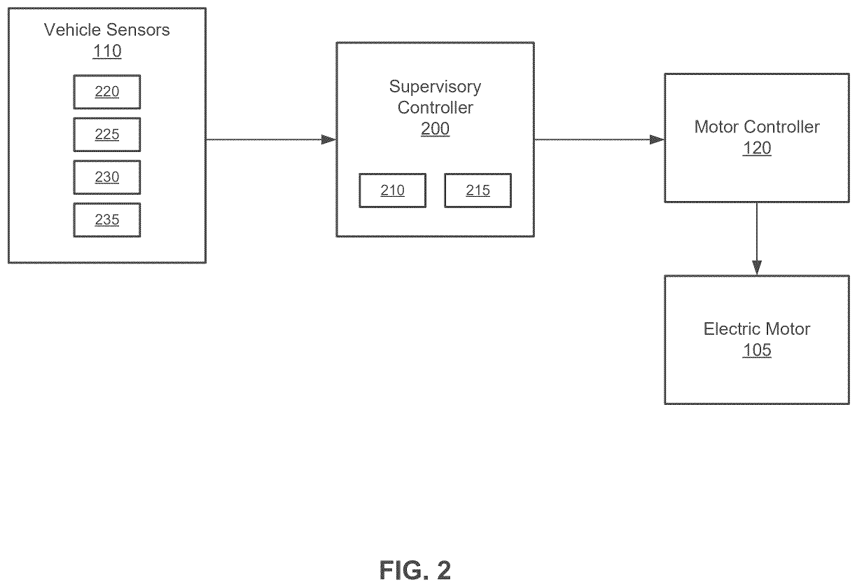

The vehicle sensors 110 may be one or more electronic devices configured to capture and relay information regarding the operational and readiness state of the work machine 100. The vehicle sensors 110 may be configured to provide real-time data on various aspects of a condition of the work machine 100. For example, a brake actuation sensor (see FIG. 2) may be configured to detect when an operator actuates a brake pedal. A gear selection sensor (see FIG. 2) may be configured to monitor a transmission state of the work machine 100. The transmission state may include a Park state, a Reverse state, a Drive state, or a Neutral state, among other examples. A payload sensor may be configured to determine a presence and magnitude of a payload in a bed of the work machine 100. The vehicle sensors 110 may be configured to output vehicle status signals to the control system 115.

The control system 115 may include one or more electronic devices configured to receive the vehicle status signals output by the vehicle sensors 110 and output one or more control signals to the motor controller 120. For example, the control system 115 may be configured to determine a readiness state of the work machine 100 in accordance with outputs of the vehicle sensors 110. The readiness state may be associated with a likelihood of movement of the work machine 100. For example, the readiness state may be associated with the likelihood that the electric motor 105 may need to be used to propel the work machine 100 within a short period of time, such as 2-5 seconds. The control system 115 may be configured to output a control signal commanding the motor controller 120 to perform a fluxing operation on the electric motor 105 in accordance with the readiness state.

As indicated above, FIG. 1 is provided as an example. Other examples may differ from what is described with regard to FIG. 1.

FIG. 2 is a diagram of an example supervisory controller 200 associated with performing a fluxing operation. As shown in FIG. 2, the example supervisory controller 200 includes one or more memories 210 and one or more processors 215. The supervisory controller 200 may be configured to receive one or more vehicle status signals output by the vehicle sensors 110, determine a readiness state for vehicle movement in accordance with one or more of the vehicle status signals, and output a control signal commanding the motor controller 120 to perform a fluxing operation on the electric motor 105 in accordance with the readiness state.

As shown in FIG. 2, the vehicle sensors 110 may include a brake pedal sensor 220, a payload sensor 225, a gear selection sensor 230, a vehicle pitch sensor 235, and/or a combination thereof, among other examples.

The brake pedal sensor 220 may be implemented via circuits, chips, or other electronic components configured to detect actuation of a brake pedal. For example, the brake pedal sensor 220 may include an encoder or a proximity sensor configured to detect when a user of the work machine 100 has pressed or released the brake pedal. The brake pedal sensor 220 may be configured to output a brake pedal actuation signal indicating the actuation of the brake pedal. The brake pedal sensor 220 may be configured to output the brake pedal actuation signal to the supervisory controller 200.

The payload sensor 225 may be implemented via circuits, chips, or other electronic components configured to detect a payload in, for example, a bed of the work machine 100. The payload sensor 225 may include a load cell configured to output a payload signal indicating a weight applied to the bed of the work machine 100.

The gear selection sensor 230 may be implemented via circuits, chips, or other electronic components configured to detect a vehicle gear selection. For example, the gear selection sensor 230 may include an encoder or proximity sensor configured to detect a position of a gear shifter. The vehicle gear selection may indicate that the work machine 100 is in a Park state, a Reverse state, a Drive state, a Neutral state, among other examples. The gear selection sensor 230 may be configured to output a gear selection signal indicating the vehicle gear selection.

The vehicle pitch sensor 235 may be implemented via circuits, chips, or other electronic components configured to detect a change in a pitch of the work machine 100. The vehicle pitch sensor 235 may be configured to output a vehicle pitch signal indicating a change in a pitch of the work machine 100. The pitch of the work machine 100 may be a slope of a first part of the work machine 100 relative to a second part of the work machine 100. The first part and the second part of the work machine 100 may be on opposite sides of a fulcrum. The presence and/or magnitude of the pitch may indicate that the payload has been applied to the bed of the work machine 100. For example, when a payload is added to the bed of the work machine 100, the rear (e.g., the first side) of the work machine 100 may be lower than the front (e.g., the second side) of the work machine. Accordingly, the change in vehicle pitch may indicate a change with respect to the payload, as discussed above.

The one or more memories 210 may be implemented via circuits, chips, or other electronic components and can include one or more of read only memory (ROM), random access memory (RAM), flash memory, electrically programmable memory (EPROM), electrically programmable and erasable memory (EEPROM), an embedded MultiMediaCard (eMMC), a hard drive, or any volatile or non-volatile media. The one or more memories may store instructions executable by the one or more processors 215. The instructions stored in the one or more memories 210 may be accessible to the processor 215 and possibly other components of the supervisory controller 200 and/or work machine 100.

The one or more processors 215 may be implemented via circuits, chips, or other electronic components and may include one or more microcontrollers, one or more field programmable gate arrays (FPGAs), one or more application specific integrated circuits (ASICs), one or more digital signal processors (DSPs), one or more customer specific integrated circuits, and/or a combination thereof, among other examples. The one or more processors 215 may be configured to receive the one or more vehicle status signals output by the one or more vehicle sensors 110, determine a readiness state for vehicle movement, and output a control signal to the motor controller 120 to command the motor controller 120 to perform the fluxing operation on the electric motor 105 in accordance with the readiness state.

The one or more processors 215 may be configured to determine the readiness state of the work machine 100 based on the outputs of one or more of the vehicle sensors 110. For example, the one or more processors 215 may be configured to determine that the brake pedal has been actuated as a result of receiving the brake pedal actuation signal and determine that a user of the work machine 100 intends to operate the work machine 100 as a result of the user actuating the brake pedal, particularly if actuating the brake pedal is a necessary step to begin driving the work machine 100.

Alternatively or in addition, the one or more processors 215 may be configured to determine the readiness state of the work machine 100 based on the vehicle payload signal output by the vehicle payload sensor 225 and/or the vehicle pitch signal output by the vehicle pitch sensor 235. For example, the vehicle payload signal and/or the vehicle pitch signal may indicate that the vehicle has received a payload, that a payload has been removed (e.g., the bed of the work machine 100 has been emptied), that a payload has changed, a decrease in the rate of change of the payload (e.g., when the rate of change is zero, the one or more processors 215 may be configured to determine that the bed of the work machine 100 is full or empty), and/or a combination thereof, among other examples. The one or more processors 215 may be configured to determine that the electric motor 105 may be needed to propel the work machine 100 as a result of the output of the vehicle payload signal output by the payload sensor 225 and/or the vehicle pitch signal output by the vehicle pitch sensor 235.

Alternatively or in addition, the one or more processors 215 may be configured to determine the readiness state of the work machine 100 based on the gear selection signal output by the gear selection sensor 230. For example, when the user shifts the work machine 100 out of a Park state, to the Reverse state, and/or to the Drive state, the one or more processors 215 may be configured to determine that the electric motor 105 may be needed to propel the work machine 100.

The one or more processors 215 may be configured to determine the readiness state of the work machine 100 based on a combination of signals output by the vehicle sensors 110. For example, the one or more processors 215 may be configured to determine the readiness state of the work machine 100 in accordance with the brake pedal actuation signal and the gear selection signal since a user of the work machine 100 may press the brake pedal and shift the work machine out of the Park state when the user intends to drive the work machine 100.

The one or more processors 215 may be configured to output, to the motor controller 120, a control signal commanding the motor controller 120 to perform the fluxing operation on the electric motor 105. The one or more processors 215 may be configured to output the control signal in accordance with the readiness state of the work machine 100. For example, the one or more processors 215 may be configured to output the control signal as a result of determining that the readiness state indicates that the user of the work machine 100 intends to drive the work machine.

The motor controller 120 may be configured to initiate the fluxing operation on the electric motor 105 as a result of receiving the control signal output by the one or more processors 215. The fluxing operation may include connecting the electric motor 105 to a power source (e.g., a battery or fuel cell) to energize the windings of the stator to generate a magnetic flux that can be used to propel the work machine 100.

If the readiness state is unknown, the motor controller 120 may need to continuously perform the fluxing operation so that the work machine 100 is available for the user to drive. Continuously performing the fluxing operation may result in excessive energy usage and wear on the electric motor 105. Therefore, by outputting the control signal to the motor controller 120 in accordance with the readiness state, the motor controller 120 may initiate the fluxing operation only when the work machine 100 is most likely to be driven, which can result in lower energy costs and extend the life of the electric motor 105 and possibly other components of the work machine 100.

As indicated above, FIG. 2 is provided as an example. Other examples may differ from what is described with regard to FIG. 2.

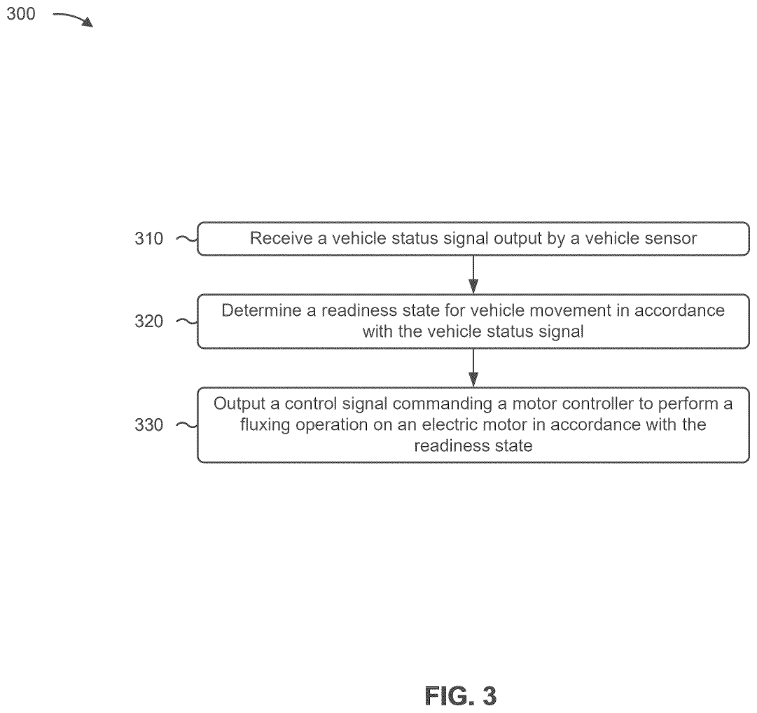

FIG. 3 is a flowchart of an example process 300 associated with performing a fluxing operation on an electric motor of a work machine. One or more process blocks of FIG. 3 may be performed by a supervisory controller (e.g., supervisory controller 200). Additionally, or alternatively, one or more process blocks of FIG. 3 may be performed by another device or a group of devices separate from or including the supervisory controller, such as another device or component that is internal or external to the supervisory controller and/or work machine (e.g., work machine 100).

As shown in FIG. 3, process 300 may include receiving a vehicle status signal output by a vehicle sensor (block 310). For example, the supervisory controller may receive a vehicle status signal output by a vehicle sensor, as described above. The vehicle status signal may indicate actuation of a brake pedal, a change in a vehicle gear selection, a change in a vehicle payload, a presence of a vehicle payload, a change in a vehicle pitch, and/or a combination thereof, among other examples.

As further shown in FIG. 3, process 300 may include determining a readiness state for vehicle movement in accordance with the vehicle status signal (block 320). For example, the supervisory controller may determine a readiness state for vehicle movement in accordance with the vehicle status signal, as described above.

As further shown in FIG. 3, process 300 may include outputting a control signal commanding a motor controller to perform a fluxing operation on an electric motor in accordance with the readiness state (block 330). For example, the supervisory controller may output a control signal commanding a motor controller to perform a fluxing operation on an electric motor in accordance with the readiness state, as described above.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

Work machines that use an electric motor for propulsion may experience a propulsion lag if the electric motor is not energized before the work machine is expected to move. Continuously keeping the electric motor energized can waste energy and reduce the operating life of the electric motor. Rather than continuously performing fluxing operations to energize the electric motor, the fluxing operation need only be performed immediately before the electric motor is expected to propel the work machine. For example, the supervisory controller may initiate the fluxing operation in accordance with a readiness state of the work machine. The readiness state may be determined in accordance with signals output by one or more vehicle sensors, and the supervisory controller may output a control signal to initiate the fluxing operation in accordance with the readiness state. By performing the fluxing operation in accordance with the readiness state for vehicle movement, the work machine may use less energy, and the life of the electric motor may be extended.

What is claimed is:

1. A machine, comprising:
one or more sensors, each being configured to monitor a vehicle status and output a vehicle status signal;
an electric motor;
a motor controller configured to perform a fluxing operation on the electric motor; and
a supervisory controller configured to receive the one or more vehicle status signals output by the one or more sensors, determine a readiness state for vehicle movement, and output a control signal to the motor controller to command the motor controller to perform the fluxing operation on the electric motor in accordance with the readiness state.

2. The machine of claim 1, wherein the one or more sensors include a brake pedal sensor configured to detect actuation of a brake pedal and output a brake pedal actuation signal indicating the actuation of the brake pedal.

3. The machine of claim 1, wherein the one or more sensors include a payload sensor configured to detect a vehicle payload and output a vehicle payload signal indicating the vehicle payload.

4. The machine of claim 1, wherein the one or more sensors include a gear selection sensor configured to detect a vehicle gear selection and output a gear selection signal indicating the vehicle gear selection.

5. The machine of claim 1, wherein the supervisory controller is configured to determine the readiness state for vehicle movement based on a combination of the one or more vehicle status signals output by the one or more sensors.

6. A supervisory controller, comprising:
one or more memories; and
one or more processors, communicatively coupled to the one or more memories, configured to:
receive one or more vehicle status signals output by one or more vehicle sensors;
determine a readiness state for vehicle movement in accordance with the one or more vehicle status signals; and
output a control signal commanding a motor controller to perform a fluxing operation on an electric motor in accordance with the readiness state.

7. The supervisory controller of claim 6, wherein the one or more vehicle status signals indicate actuation of a brake pedal.

8. The supervisory controller of claim 7, wherein the one or more processors are further configured to monitor the one or more vehicle status signals indicating the actuation of the brake pedal during a gear selection.

9. The supervisory controller of claim 6, wherein the one or more processors are further configured to determine the readiness state for vehicle movement in accordance with two or more vehicle status signals.

10. The supervisory controller of claim 9, wherein the two or more vehicle status signals are each received from different vehicle sensors.

11. The supervisory controller of claim 6, wherein the one or more vehicle status signals indicates a change in a gear selection.

12. The supervisory controller of claim 6, wherein the one or more vehicle status signals indicates a change in a vehicle payload.

13. The supervisory controller of claim 6, wherein the one or more vehicle status signals indicates a presence of a vehicle payload.

14. The supervisory controller of claim 6, wherein the one or more vehicle status signals indicates a change in a vehicle pitch.

15. A method, comprising:
receiving a vehicle status signal output by a vehicle sensor;
determining a readiness state for vehicle movement in accordance with the vehicle status signal; and
outputting a control signal commanding a motor controller to perform a fluxing operation on an electric motor in accordance with the readiness state.

16. The method of claim 15, wherein the vehicle status signal indicates actuation of a brake pedal.

17. The method of claim 15, wherein the vehicle status signal indicates a change in a vehicle gear selection.

18. The method of claim 15, wherein the vehicle status signal indicates a change in a vehicle payload.

19. The method of claim 15, wherein the vehicle status signal indicates a presence of a vehicle payload.

20. The method of claim 15, wherein the vehicle status signal indicates a change in a vehicle pitch.
